(19) United States
(12) Patent Application Publication
(10) Pub. No.: US 2026/0304209 A1
(43) Pub. Date: Oct. 1, 2026

(54) METHODS, ARCHITECTURES, APPARATUSES AND SYSTEMS FOR UPDATING SENSING TASKS BASED ON PERFORMANCE MONITORING

(71) Applicant: InterDigital Patent Holdings, Inc., Wilmington, DE (US)

(72) Inventors: Magurawalage Chathura Madhusanka Sarathchandra, London (GB); Jung Je Son, Warrington, PA (US); Catalina Mladin, Hatboro, PA (US); Zhibi Wang, Woodridge, IL (US); Filipe Conceicao, London (GB)

(21) Appl. No.: 19/093,125

(22) Filed: Mar. 27, 2025

(51) Int. Cl. H04W 28/02; H04W 24/02

(52) U.S. Cl. CPC H04W 28/0268; H04W 24/02

(57) ABSTRACT

This disclosure is related to updating sensing tasks based on performance monitoring. A core network generates information for a sensing task indicating sensing information and condition monitoring information. A core network causes the information for a sensing task to be transmitted to a sensing entity. The core network receives quality of service change (QoS) information. The core network determines that a QoS associated with the sensing task is insufficient. The core network determines at least one modification to the sensing task based on the QoS change information and determines that the QoS associated with the sensing task is insufficient. The core network generates updated sensing task information based on the at least one modification. The core network causes the updated sensing task information to be transmitted to at least one sensing entity. The at least one sensing entity is configured based on the updated sensing task information.

### TECHNICAL FIELD

The present disclosure is generally directed to the fields of communications, software and encoding/decoding, including, for example, to methods, architectures, apparatuses, systems related to updating sensing tasks based on performance monitoring.

### BACKGROUND

When a wireless transmit/receive unit (or any suitable sensing entity) is performing a sensing task, environmental changes may reduce the quality of sensing results. For example, a wireless transmit/receive unit may detect that its line of sight to a target sensing object is physically obstructed. As such, a wireless transmit/receive unit may perform a sensing task but generate sensing results with a reduced quality even if another wireless transmit/receive unit may be available to generate sensing results with a better quality.

### SUMMARY

In accordance with certain representative embodiments of the present disclosure, methods and systems are provided for updating sensing entities based on changes in the quality of service of a sensing task. A method may be performed by a core network, and such a method includes generating information for a sensing task indicating sensing information and condition monitoring information. Condition monitoring information indicates at least one condition to be monitored. The method further includes causing the information for the sensing task to be transmitted to a sensing entity. The method also includes receiving quality of service (QoS) change information indicating a change in the at least one condition. The method additionally includes determining that a QoS associated with the sensing task is insufficient based on the QoS change information. The method furthermore includes determining at least one modification to the sensing task based on the QoS change information and determining that the QoS associated with the sensing task is insufficient. The method moreover includes generating updated sensing task information based on the at least one modification. The method additionally includes causing the updated sensing task information to be transmitted to at least one sensing entity, wherein the at least one sensing entity is configured based on the updated sensing task information.

In certain representative embodiments, receiving the QoS change information includes receiving the QoS change information from any one of a sensing entity or a network function of the core network.

In certain representative embodiments, the core network includes a sensing network function.

In certain representative embodiments, the updated sensing task information includes an instruction causing the at least one sensing entity to terminate a respective sensing task.

In certain representative embodiments, the updated sensing task information includes an instruction to initiate a respective sensing task using the at least one sensing entity

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 1E is a system diagram illustrating an example core network that includes hardware and software for implementing the functionality of network functions included in the core network, such as those illustrated in FIG. 1A, according to one or more embodiments of this disclosure;

FIG. 2 shows an illustrative reference model of a wireless network, according to one or more embodiments of this disclosure;

FIG. 3 illustrates an example of pedestrian and/or animal intrusion detection, according to one or more embodiments of this disclosure;

FIG. 4 illustrates an example of intruder detection in surroundings of a smart home, according to one or more embodiments of this disclosure;

FIG. 5A illustrates an example of multiple access channel with mono-static base station sensing, according to one or more embodiments of this disclosure;

FIG. 5B illustrates an example of a multiple access channel with bi-static base station sensing, according to one or more embodiments of this disclosure;

FIG. 6 is a sequence diagram of illustrative operations showing how a sensing network function may update a sensing task based on information received from a sensing entity, according to one or more embodiments of this disclosure;

FIG. 7 is a sequence diagram of illustrative operations showing how a sensing network function, sensing processing entity, and a sensing data consumer interact to update a sensing task, according to one or more embodiments of this disclosure;

FIG. 8 is a sequence diagram of illustrative operations showing how sensing entities may be reselected for a sensing task once a change in the quality of service of a sensing task has been detected by a sensing entity, according to one or more embodiments of this disclosure; and

FIG. 9 is a flowchart of illustrative steps for updating a sensing task based on quality of service (QoS), according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

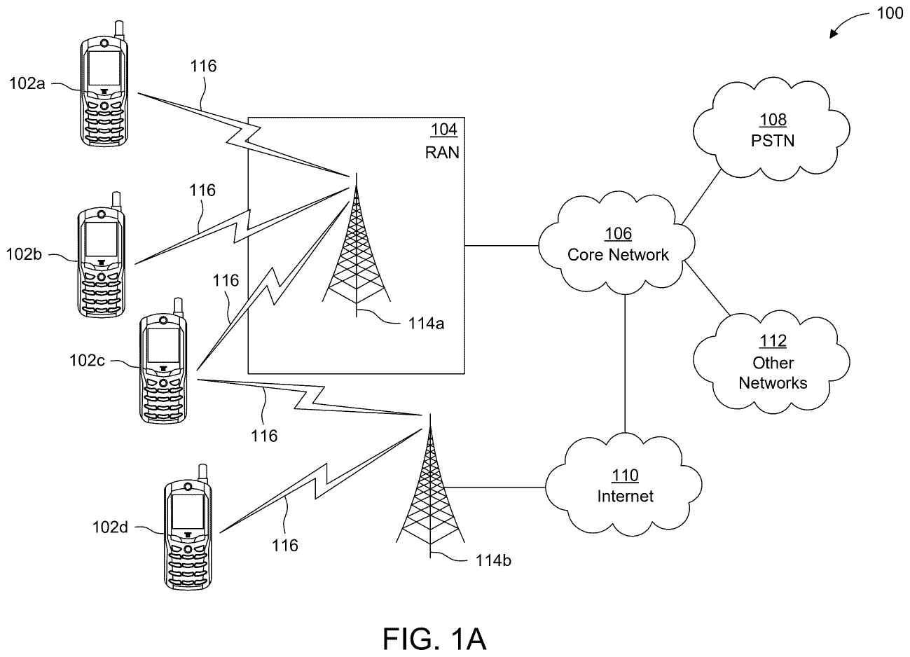

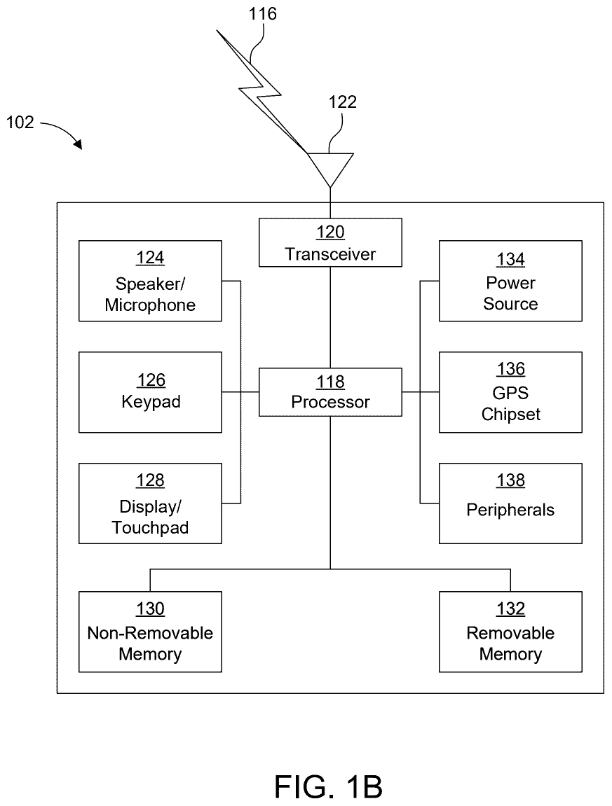

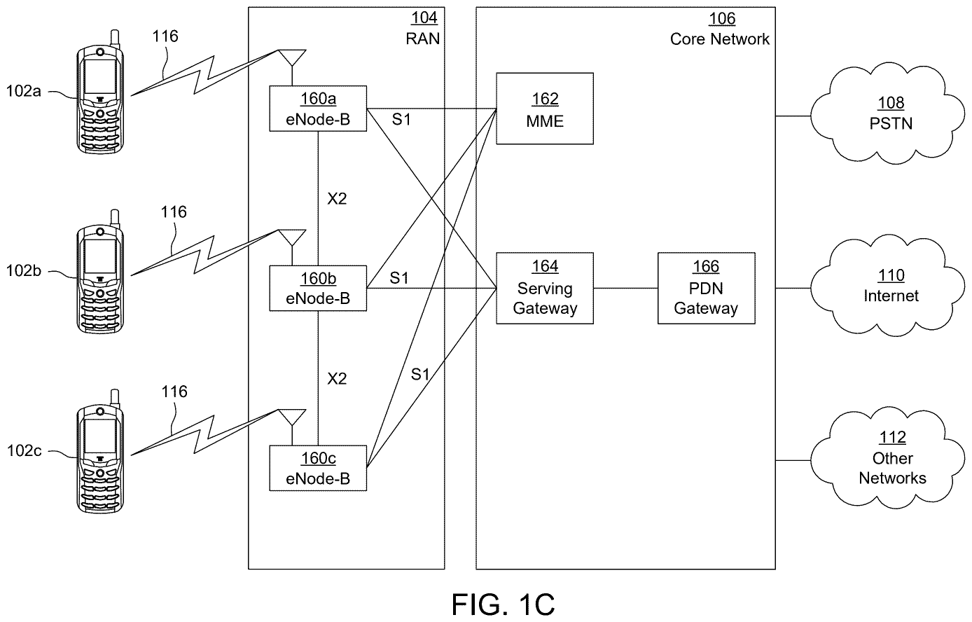

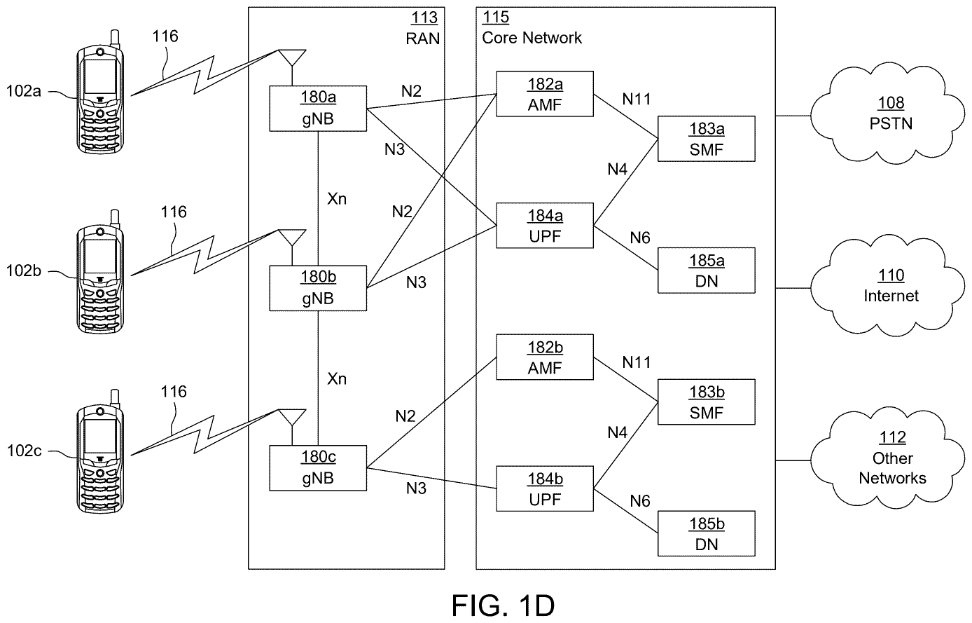

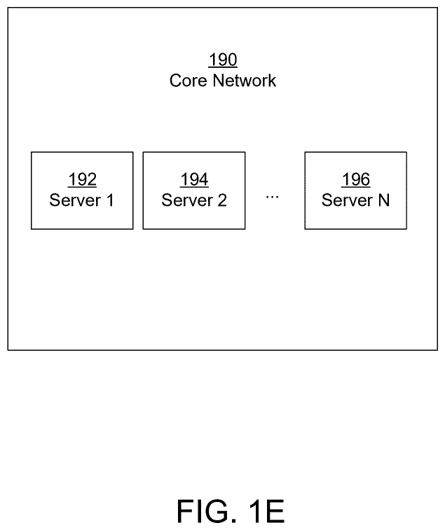

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa, for example, if the WTRU includes only one active UE.

As used herein, a sensing entity (interchangeably also referred to as a sensing device, a sensor, a sensor node, or a sensing node) may refer to any device that can perform sensing based on a wireless signal, including but not limited to any of the WTRUs 102a, 102b, 102c and 102d, any UE, any base station (e.g., base station 114a of RAN 104, or base station 114b), any suitable eNode-B (e.g., any eNode-B 160a, 160b, or 160c), any suitable gNode-B (e.g., any gNode-B 180a, 180b, or 180c), any hardware of a core network (e.g., hardware configured to execute any access and mobility function (AMF), user plane function (UPF), session management function (SMF) or data network (DN) of a core network), or any other suitable device.

The communications systems 100 may also include a base station 114a and/or a base station 114b. Each of the base stations 114a, 114b may be any type of device configured to wirelessly interface with at least one of the WTRUs 102a, 102b, 102c, 102d, for example, to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, that is, one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b need not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, for example, in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode need not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards UPFs 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one SMF 183a, 183b, and at least one DN 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, for example, to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The MME 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, for example, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

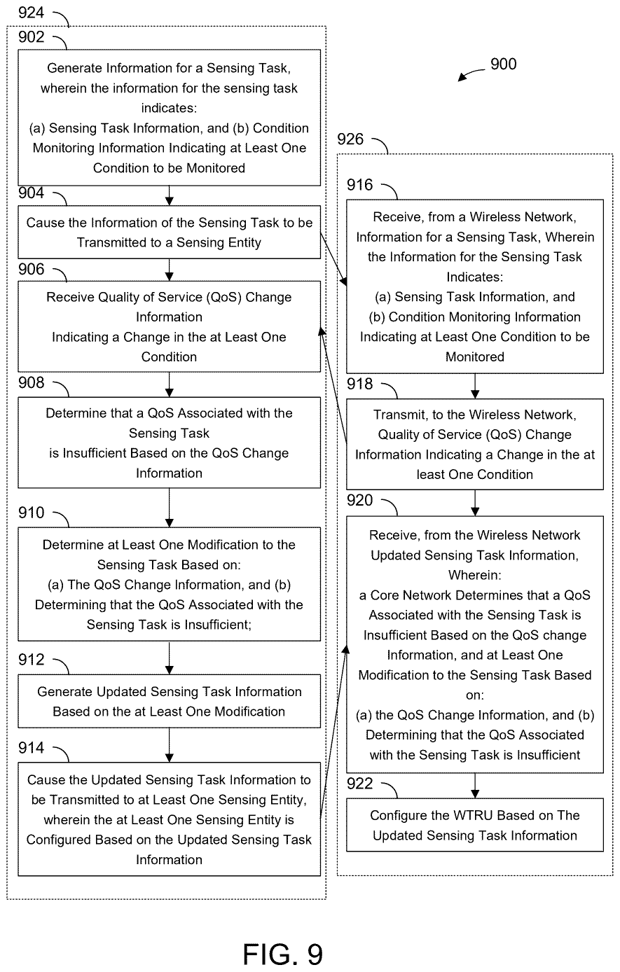

FIG. 1E is a system diagram illustrating an example core network that includes hardware and software for implementing the functionality of network functions included in the core network, such as those illustrated in FIG. 1A, according to one or more embodiments of this disclosure. Core network 190 may correspond to any of previously described core networks 103 or 115. Core network 190 may be implemented using any suitable hardware, software, or both. For purposes of illustration, and not by way of limitation, core network 190 is described herein as being implemented using one or more of servers 192-196 and may include at least one processor (e.g., configured to perform any of operations 902-914 as described in connection with FIG. 9). It will be understood that any other suitable software, hardware, or both may be used in place of or in addition to servers 192-196. The functionality of any network function (e.g., any one or more of AMF 182a-182b, SMF 183a-183b, and UPF 184a-184b) may at least be partially implemented in one or more of servers 192-196. Furthermore, a sensing network function, sensing data consumer, and a sensing processing entity may be at least partially implemented in one or more of servers 192-196. While a sensing network function provides functionalities described further below in this disclosure, it will be understood that at least some of the described functionalities may be implemented in other existing network functions. For example, a sensing network function may be implemented as part of an SMF. In certain representative embodiments, there need not be a standalone sensing network function, and the functionalities provided by a sensing network function may be implemented in other existing network functions (e.g., any one or more of AMF 182a-182b, SMF 183a-183b, and UPF 184a-184b). Moreover, a sensing data consumer may be configured to consume data within a 3GPP system; the sensing data consumer may be an application function or application server provided for an application. Additionally, as shown in FIG. 1E, “N” of Server N 196 may represent any suitable integer.

It will be understood that a wireless network may include any suitable components and devices, including, for example, any of one or more base stations, one or more TRPs, one or more gNBs, one or more WTRUs, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

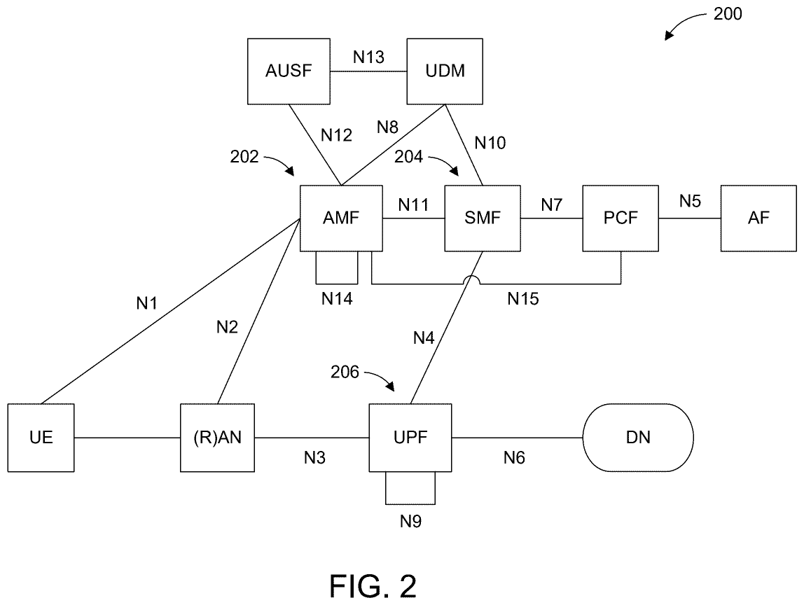

In accordance with some embodiments of this disclosure, the devices and systems of FIGS. 1A-1D may be used in connection with devices, systems, and methods for sensor reconfiguration. For example, in some embodiments of this disclosure, the devices and systems of FIGS. 1A-1D may be used in connection with the devices, systems, and methods described in FIGS. 2-9.

In accordance with some embodiments of this disclosure, a reference model of a 5G network, or other suitable network, is shown in FIG. 2 and described as follows. FIG. 2 illustrates an example of a reference model of a network architecture (e.g., a 5G or NextGen network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), UE IP address allocation, selection, and control of UPFs. In certain representative embodiments, UPF 206 (e.g., which may be the same as UPF 184a or 184b) includes the functionalities of packet routing, packet forwarding, packet inspection, and traffic usage reporting.

In certain representative embodiments of this disclosure, integrated sensing capabilities and potential systems, methods, and devices for enhancing current 5G systems/standards are provided. For example, the enhancements may provide sensing services addressing different target verticals/applications (e.g., autonomous/assisted driving, vehicle-to-everything, unmanned aerial vehicles, 3D map, smart city, smart home, factories, healthcare, or maritime sector). In integrated sensing applications, there is a process of collecting sensing measurement data. The sensing measurement data, for example, may be data collected about radio/wireless signals impacted (e.g., reflected, refracted, diffracted) by an object or by an environment of interest for sensing purposes. A further example of generating sensing measurement data may be deriving sensing results from processing sensing measurement data. There may also be an area defined for sensing such as a sensing service area (SSA) location, which may be an area or location (with or without at least one obstacle) in which the SSA can provide sensing service with target quality.

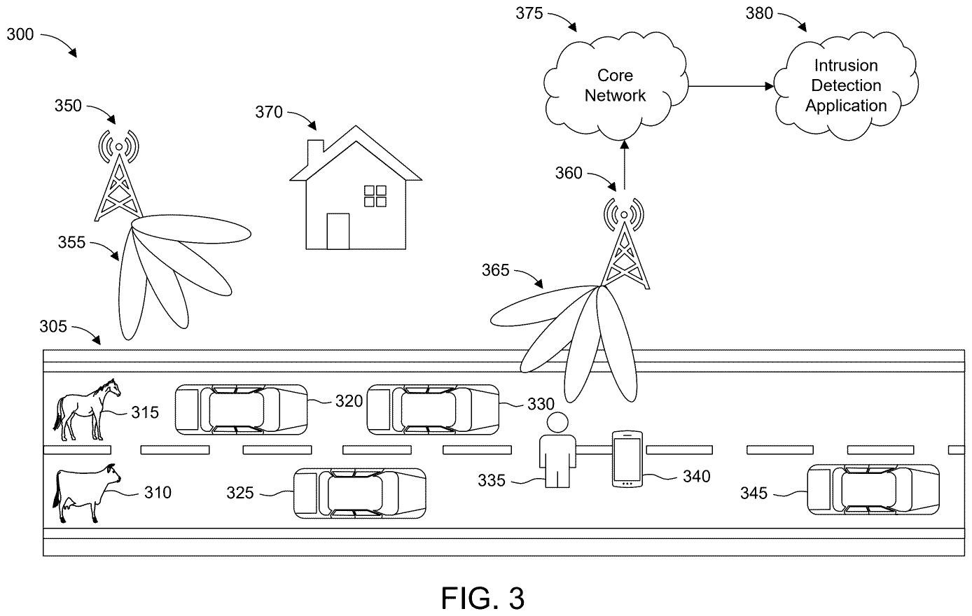

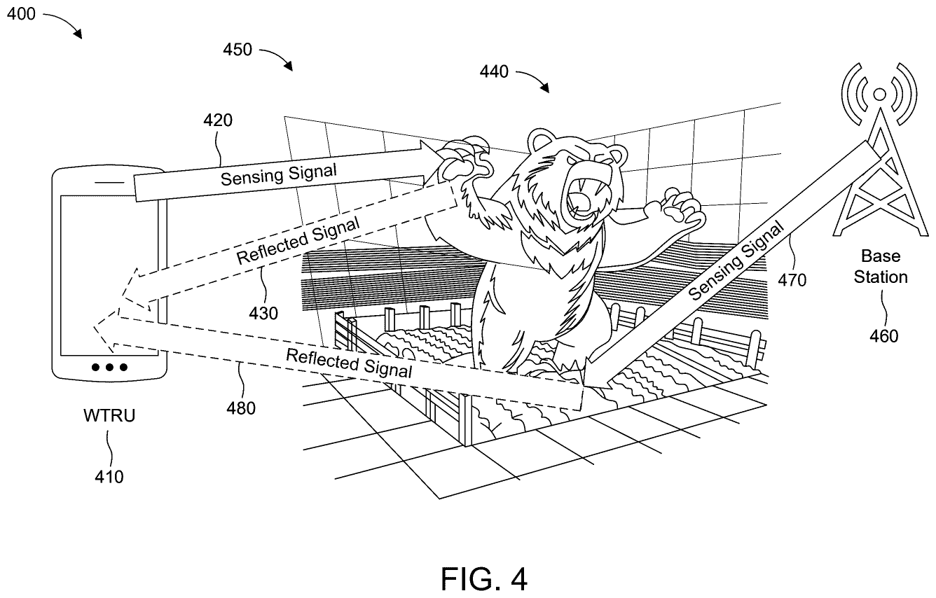

An illustrative use case for integrated sensing is object detection. For example, detection of pedestrian and/or animal intrusion detection on a highway (see, for example, FIG. 3), or detection of an intruder in surroundings of a smart home (see, for example, FIG. 4), are considered.

As shown in FIG. 3, for example, in an outdoor environment 300, pedestrian and/or animal intrusion detection is provided. Environment 300 includes highway 305 and residential property 370 adjacent to highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as first animal (e.g., cow) 310, second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, the pedestrian 335 carrying a WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track objects 310-345, for example, with respect to base stations 350, 360 and/or one or more fixed points along highway 305 and/or property 370. Intrusion detection application 380 may be configured to differentiate between different types of vehicles (e.g., compact vehicle 325 versus large vehicle 345) or different types of objects (e.g., horse 315 versus human 335) and corresponding locations, directions of movement, velocities, or the like.

As shown in FIG. 4, for example, in outdoor environment 400, intruder detection in surroundings 450 of a smart home is provided. Environment 400 includes WTRU 410 (e.g., which may be the same as WTRU 102a, 102b, 102c, 102d, or 340), intruder (e.g., a bear) 440, and base station 460. WTRU 410 is configured to transmit a sensing signal 420, which, in this example, is incident on intruder 440. WTRU 410 is configured to receive reflected signal 430, which, in this example, reflects sensing signal 420 after incidence with intruder 440. Base station 460 is configured to transmit sensing signal 470, which, in this example, is incident on surroundings (e.g., the ground) 450. WTRU 410 is configured to receive reflected signal 480, which, in this example, reflects sensing signal 470 after incidence with the surroundings 450.

In the scenarios of FIG. 3 and FIG. 4, base station (e.g., 350, 360, 460) and/or WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing wherein sensing data is captured by a WTRU and communicated so that 5GS is aware of the sensing information. The WTRU may acquire sensing measurements from different 3GPP and non-3GPP devices. 5GC may determine various available sensing services by processing collated sensing data.

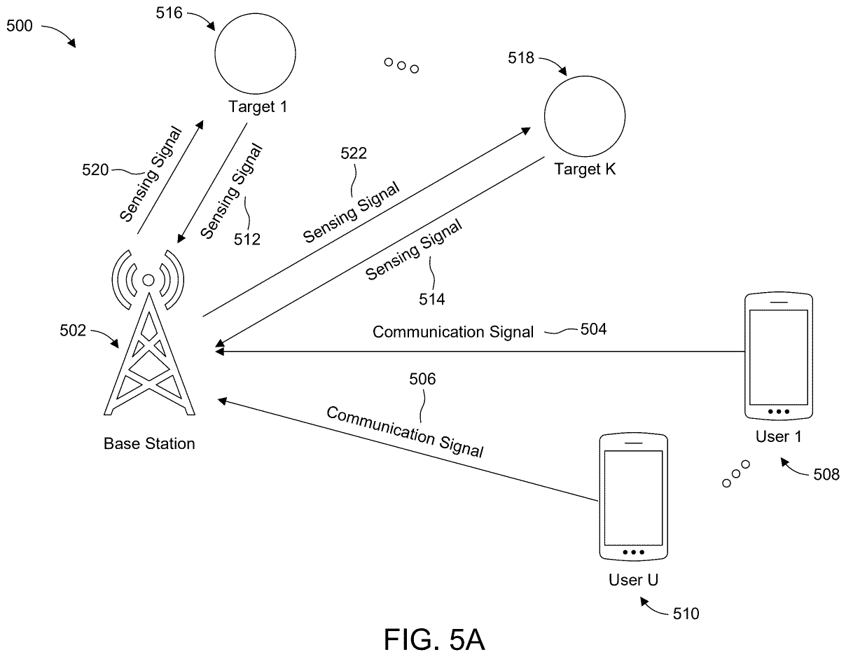

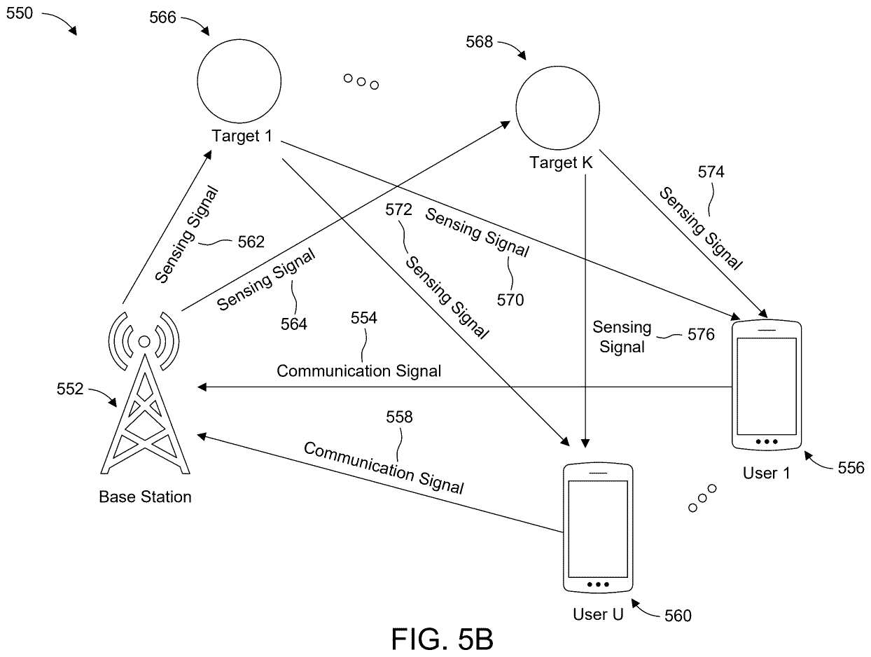

FIG. 5A illustrates an example of monostatic sensing wherein the sensing signal sender and receiver are the same node according to some embodiments of the disclosure. For example, in environment 500, base station 502 (e.g., which may be the same as base station 114a, 114b, 350, 360, or 460) may send first sensing signal (e.g., sensing signal 520 or 522) and receive second sensing signal (e.g., sensing signal 512 or 514) as a reflection of the first signal. Base station 502 may also receive communication signals 504 and/or 506 from user devices 508 and 510, respectively. Communication signals 504 and/or 506 may indicate an outcome of a sensing operation, and/or may trigger a reconfiguration (e.g., including any suitable details of the reconfiguration). As shown in FIG. 5A, “K” of “Target K” and “U” of “User U” may represent any suitable integers. It will be understood that, for example, if U equals five, then there would be five respective user devices (although only two are shown for illustrative purposes). It will also be understood that, for example, if K equals three, there would be three respective targets (although only two are shown for illustrative purposes).

FIG. 5B illustrates an example of bi-static sensing wherein the sensing signal sender and sensing signal receiver are two different nodes. For example, in environment 550, base station 552 (e.g., which may be the same as base station 114a, 114b, or 502) may receive a communication signal 554 from user device 556 and receive communication signal 558 from user device 560. The base station 552 may also send first sensing signals 562 and 564 to targets 566 and 568, respectively. A target may reflect a first sensing signal to generate a second sensing signal (e.g., sensing signal 570 or 572) that may be recorded at a user device receiving the sensing signal. TAs shown in FIG. 5B, “K” of “Target K” and “U” of “User U” may represent any suitable integers. It will be understood that, for example, if U equals five, then there would be five respective user devices although only two are shown. It will also be understood that, for example, if K equals three, there would be three respective targets although only two are shown.

In this disclosure, sensing features refer to the physical features or properties of the sensing target (object, environment) that are reflected on the sensing data. The features and the properties sensed by a sensor node may change depending various factors in relation to the sensing target. For example, the location of a sensor node, with respect to the sensing target, may determine which part of the sensed object is visible to the sensor and which parts of the sensed object are hidden. Therefore, not all features of the target object may be detected by the sensor

Environmental conditions (e.g., obstructions to radio signals from moving vehicles or people) can reduce the quality of sensing results and sensing QoS or quality of experience (QoE).

It may be desirable to detect factors or events that may cause reductions to sensing QoS (e.g., due to obstructions). Moreover, it may be necessary to re-evaluate existing sensing entities (e.g., gNBs) and reselect new sensing entities that can meet sensing QoS of a task if a factor or event reduces sensing QoS.

Regardless of the sensing modality used (e.g., monostatic or bistatic), the 5G system should select sensing entities that have obstruction-free sensing radio sensing paths or sensing entities that can produce high quality sensing results that meet QoS requirements of the sensing task.

As such, it may be desirable to determine whether sensing QoS is reduced (e.g., due to changes in environment such as obstructions) and to reselect sensing entities with a better sensing QoS.

A WTRU with sensing capabilities may be configured to sense various properties (e.g., location, velocity, direction) of physical objects or the environment using various sensors independently. A network entity may determine factors or events which can affect sensing QoS (i.e., QoS of a sensing task) and lead to QoS reductions in a sensing task. A method for reselecting new sensing entities as a result of the changes in QoS of a sensing task is described herein.

In accordance with one or more embodiments of this disclosure, a sensing network function may receive a notification indicating change in sensing performance from a sensing entity (which may be interchangeably referred to as a WTRU, UE, or RAN node) or receive a notification indicative of a change in QoS from an application server (AS) or network function (NF) such as a sensing processing entity. The functionality of a sensing processing entity may be implemented by any one or more of an AF, NF, or AS.

In certain representative embodiments, a sensing network function may determine the reason for the change in QoS. In certain representative embodiments, a sensing NF or a sensing processing entity may determine whether the change in QoS is temporary or not. A sensing network function may send a message to a sensing data consumer indicating the reason for the change in the QoS, whether the change in the QoS is temporary, and how long the change in the QoS may last for. The functionality of a sensing data consumer may be implemented by any one or more of an AF, NF, or AS.

In certain representative embodiments, a sensing network function may receive a request to terminate a sensing task (e.g., with respect to a WTRU performing the sensing task) from a sensing data consumer. Similarly, a sensing network function may receive a request from the sensing data consumer to update a sensing task (e.g., with respect to a WTRU performing the sensing task) from a sensing data consumer. In certain representative embodiments where the sensing data consumer is an AF or an AS, the request may be sent via a network exposure function (NEF).

In accordance with one or more embodiments of this disclosure, a sensing network function may determine to update the sensing task performed by one or more WTRUs. A sensing network function may determine that the QoS of a sensing task may be reduced, and the sensing network function may determine that sensing entities currently performing a sensing task may need to be replaced with other sensing entities better suited for performing the sensing task. The sensing network function may send a request to perform a sensing task to a newly selected sensing entity (e.g., based on determining which sensing entities are better suited for performing a sensing task). Such a request may include sensing task information and requirements needed to perform the sensing task (e.g., sensing frequency or waveform). The sensing network function may send a sensing termination or sensing update message to sensing entities that will no longer perform the sensing task. Such termination or update message may include information related to the sensing task (e.g., a sensing task identifier). The sensing network function may notify an AF, AS, or any suitable NF of the changes made to the sensing task (e.g., information related to what sensing entities were added to perform the sensing task or prevented from further performing the sensing task).

In accordance with one or more embodiments of this disclosure, a WTRU may receive a request from an SMF to monitor factors and events that may potentially affect the QoS of a sensing task. In certain representative embodiments, such a request may be instead received from a sensing network function. In certain representative embodiments, the WTRU may a detect a change in environmental conditions and determine to send sensing performance information to a wireless network. For example, the sensing entity may detect that the line of sight to the target object is obstructed due to a physical obstruction (e.g., billboard obstructing the line of sight). In certain representative embodiments, the WTRU may send sensing performance monitoring information to the sensing network function. In certain representative embodiments, a WTRU (which may be newly selected by a sensing network function) may receive a sensing request to perform a sensing task, along with information related to the sensing task and requirements of the sensing task (e.g., a required sensing frequency or waveform). Such a WTRU may begin sensing according to the sensing task and transmit sensing data to a sensing data consumer. Alternatively, in certain representative embodiments, a WTRU (which may be prevented from further performing a sensing task by a sensing network function) may receive a sensing termination request, along with information related to the sensing task (e.g., a sensing task identifier).

In this disclosure, nodes that are using their local sensing capabilities for sensing are referred to as sensing nodes, sensing WTRUs, sensing UEs, sensing RAN nodes, or sensors. Such nodes may be a WTRU, UE, RAN node, or any suitable combination thereof.

In certain representative embodiments, a sensing entity may monitor its sensing performance and report its performance to a sensing network function. Factors or events that may be monitored by the sensing entity include any one or more of the following: signal strength (of a signal reflected from the target object); a signal delay; signal interference information; a detected obstruction; a relative distance between the sensing entity and the target; a rendering range unsuitable for sensing; sensing coverage information (e.g., information indicative of whether the sensing signal is not detected by the sensing entity); communication coverage information (e.g., information indicative of whether the coverage of a sensing entity prevents the sensing entity's transmission from reaching the sensing network function or the sensing processing function); information indicative of whether a RAN node is available (e.g., whether a RAN node is unreachable with respect to a sensing network function); information related to energy consumption or charging policies of a sensing entity that may prevent the transmission of sensing signals; negative changes in signal propagation models; ray tracing related information; a time of flight (e.g., determined based on an analysis and detection of reflections and delays); a round trip time; light detection and ranging (LiDAR) and 3-dimensionall (3D) mapping analysis information; hardware performance information; information related to the mobility of the sensing entity; information related to the mobility of the sensing target; whether a potential handover procedure is expected to occur; information from an artificial intelligent (AI) model trained to detect environmental changes or any suitable algorithm; or information from a third party sensing entity indicative of environmental changes. Such factors and events may affect the QoS of a sensing task.

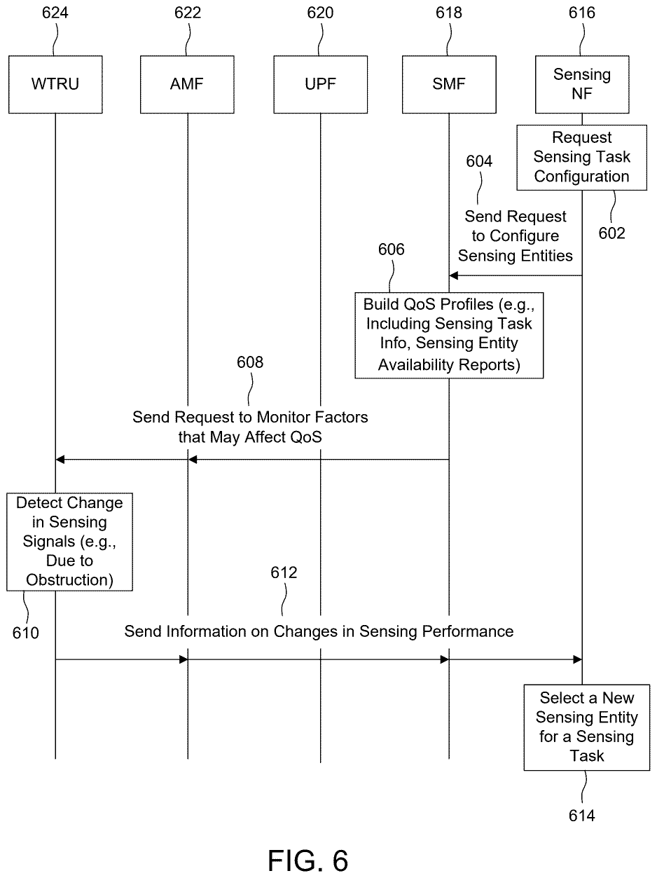

FIG. 6 is a sequence diagram of illustrative operations showing how a sensing network function may update a sensing task based on information received from a sensing entity, according to one or more embodiments of this disclosure.

At 602, sensing network function 616 is triggered to configure or request sensing performance information from WTRU 624 (which may be the same as any of WTRUs 102a-102d, 340, 410, 508, 510, 556, or 560) or any suitable one or more sensing entities. Such triggers may include any or more of the following: sensing network function 616 performing a new sensing task; sensing network function 616 receiving a request from an AF (via an NEF) to detect sensing performance of WTRU 624; an NF (e.g., network data analytics function (NWDAF)) requesting sensing performance information (e.g., based on policy or subscriber information received from an NF, SMF, or PCF); or a notification from an NF, AF, or AS that the QoS of sensing task may be affected in some manner.

At 604, sensing network function 616 sends a request to configure sensing entities to SMF 618 (which may be the same as any of SMFs 183a-183b).

At 606, SMF 618 determines whether to include certain aspects of the requested configuration specified from 604 in a message to WTRU 624. SMF 618 builds a QoS profile for WTRU 624 that may specify sensing task information and whether sensing entities should be available.

At 608, WTRU 624 receives a request from SMF 618 to monitor factors and events that may potentially affect the QoS of a sensing task. In certain representative embodiments, WTRU 624 receives a request from sensing network function 618 to monitor factors and events that may potentially affect the QoS of a sensing task. In certain representative embodiments, SMF 618 sends the request to AMF 622, and AMF 622 sends the request to WTRU 624.

At 610, WTRU 624 detects a change in environmental conditions and determines to send sensing performance information back to one or more of AMF 622 (which may be the same as any of AMFs 182a-182b), SMF 618 (which may be the same as any of SMFs 183a-183b), or sensing network function 616. For example, WTRU 624 may detect that its line of sight to a target object is obstructed due to a physical obstruction (e.g., a billboard).

In certain representative embodiments, changes of environmental conditions may be defined by a policy depending on a particular sensing task. For example, during a sensing task, a car may be moving quickly, and an obstruction may be detected. As soon as the obstruction is reported, if the LoS of the sensing entity is cleared, a policy may specify the time period (e.g., in terms of seconds or minutes) that the obstruction must be present before WTRU 624 should send the sensing performance information.

In certain representative embodiments, WTRU 624 may predict or estimate a change in sensing performance ahead of time (e.g., an obstruction or QoS condition change) to any one of sensing network function 616, SMF 618, or AMF 622. WTRU 624 may determine not to report the change in sensing performance if the environmental change is not relevant with resect to the changes requested by SMF 618 from 608.

At 612, WTRU 624 sends sensing performance information to sensing network function 616. In certain representative embodiments, WTRU 624 may send sensing performance information to AMF 622, and AMF 622 may send sensing performance information to sensing network function 616. In certain representative embodiments, WTRU 624 may send sensing performance information to AMF 622, AMF 622 may send sensing performance information to SMF 618, and SMF 618 may send sensing performance information to sensing network function 616..

At 614, based on received sensing performance information from 612, sensing network function 616 may select a new WTRU to perform the sensing task or may update the configuration of WTRUs already performing the sensing task.

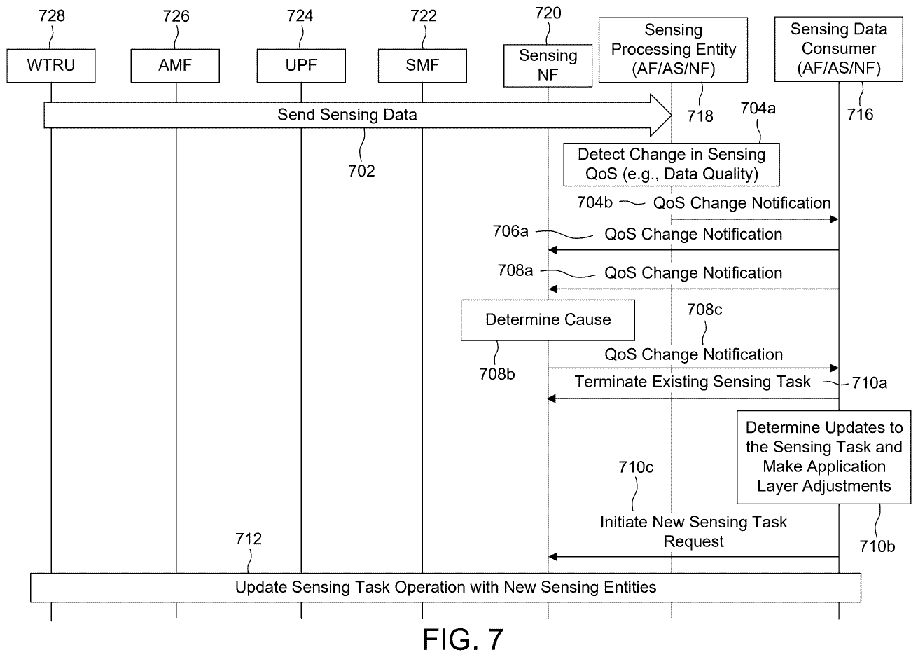

FIG. 7 is a sequence diagram of illustrative operations showing how a sensing network function, sensing processing entity, and a sensing data consumer interact to update a sensing task, according to one or more embodiments of this disclosure.

At 702, sensing processing entity 718 receives sensing data from WTRU 728 (which may be the same as any of WTRUs 102a-102d, 340, 410, 508, 510, 556, 560, or 624) or any suitable one or more sensing entities. The functionality provided by sensing processing entity 718 may be provided by any one or more of an NF, AF, or AS.

At 704a, sensing processing entity 718 determines that the sensing data from 702 does not meet the QoS of the sensing task. In certain representative embodiments, sensing processing entity 718 performs required data validity and integrity checks to ensure that received data from 702 is valid and has not been modified.

In certain representative embodiments, if sensing processing entity 718 determines that sensing performance information does not meet the QoS of the sensing task, such a determination may be due to the quality of information received. For example, WTRU 728 may detect that a target object is not sufficiently visible and that the target object may be obstructed. In another example, WTRU 728 may detect that the required features of the target object (e.g., due to the angle of WTRU 728 with respect to the target) cannot be sensed or determined.

In certain representative embodiments, if sensing processing entity 718 determines that sensing performance information does not meet the QoS of the sensing task, such a determination may be due to unsatisfactory data transmission. For example, the data transmission delay may exceed a delay threshold.

At 704b, sensing processing entity 718 sends QoS change information to sensing data consumer 716. QoS change information may include any information indicative of a change in sensing QoS (e.g., as specified by sensing network function 616 at 602). In certain representative embodiments where functionality of sensing data consumer 716 is implemented by an AF or AS, QoS change information may be sent via an NEF.

In certain representative embodiments, QoS change information may include the reason for reduced QoS. For example, QoS change information may indicate that the information of sensing target is not sufficient or that the resolution sensing data is reduced.

In certain representative embodiments, sensing data consumer 716 may decide to perform application layer adjustments based on QoS change information. For example, sensing data consumer 716 may decide to change sensing data processing parameters to reduce resolution of sensing data.

In certain representative embodiments, sensing data consumer 716 may determine to perform at least one of three options as further described below.

At 706a, as part of a first option, sensing data consumer 716 sends QoS change information to sensing network function 720 (which may be the same as sensing network function 616). In certain representative embodiments where the functionality of sensing data consumer 716 is implemented by an AF or AS, QoS change information may be sent via an NEF. QoS change information may include the reason for reduced QoS (e.g., if information about the sensing target is insufficient or if the resolution of sensing data is reduced).

At 708a, as part of a second option, sensing data consumer 716 sends QoS change information to sensing network function 720 (e.g., similarly to 706a). At 708b, sensing network function 702 determines a reason for the change in QoS. In certain representative embodiments, sensing network function 720 or sensing processing entity 718 may determine if a change in QoS will be temporary. If the change in QoS is temporary, sensing network function 720 or sensing processing entity 718 may determine or predict how long the change in QoS may last. For example, if the QoS of a sensing task is known to be affected by a known network procedure (e.g., sensing entity reselection or handover), then the change in QoS may be determined to be temporary.

In certain representative embodiments, sensing network function 720 may determine a reason for the change in QoS based on previous information sent by WTRU 728.

In certain representative embodiments, sensing network function 720 may perform radio based assessment directly on sensing data available to the sensing processing function 718. In certain representative embodiments, RAN node availability and coverage capacity may be tested via connectivity tests with respect to WTRU 728. In certain representative embodiments, policies related to charging and energy consumption with respect to WTRU 728 may require sensing network function 720 to request information regarding whether energy or charging capacities have been reached. In such embodiments, even if not explicitly specified in energy or charging policies, sensing network function 720 may request relevant information from another NF that is in charge of managing data related to energy or charging usage quantities. In certain representative embodiments, a location management function (LMF) may be used to determine a distance between WTRU 728 and a sensing target. In such embodiments, sensing network function 720 may rely on requesting and receiving positioning information for WTRU 728 and the sensing target from the LMF. Sensing network function 720 may determine whether data received from the LMF should be considered valid.

In certain representative embodiments, sensing network function 710 may determine hardware faults at WTRU 728, including RF sensing hardware faults or non-3GPP sensor hardware faults. Determination of a hardware fault may be based on received information or may be based on conclusions from events such as missing data (e.g., from a LiDAR map), reported confidence levels of sensing data exhibiting low values without an apparent reason, missing sensor data reports, or any other suitable aspect that may suggest faulty hardware.

At 708c, as part of the second option, sensing network function 720 sends a message to sensing data consumer 716. The message may indicate any of a determined reason for the change in QoS, whether the change in QoS will be temporary, and the duration that the change in QoS ay last for. Based on the received message, sensing data consumer 716 may decide what actions should be taken. If a reason for the change in QoS is specified, sensing data consumer 716 may decide to halt any changes to the sensing task (e.g., if the QoS reduction will only last for 3 seconds).

At 710a, as part of a third option, sensing data consumer 716 determines that a new sensing task should be created and sends a termination request for the sensing task to sensing network function 720. In certain representative embodiments where the functionality implemented by sensing data consumer 716 is implemented by an AF or AS, the termination request may be sent via an NEF.

At 710b, as part of the third option, sensing data consumer 716 may update the sensing task (e.g., update the QoS of the sensing task) and make changes to a configuration (e.g., resolution changes).

At 710c, as part of the fourth option, sensing data consumer 716 may send a request to initiate a new sensing task to sensing network function 720. In certain representative embodiments where the functionality implemented by sensing data consumer 716 is implemented by an AF or AS, the request for a new sensing task may be sent via an NEF.

In a fourth option, sensing data consumer 716 may determine that the sensing task should be updated (instead of terminated) based on information received during 704b. In such cases, 710b may be executed, and information sent during 710c may include a request to update the sensing task (e.g., including information of changes specified by sensing data consumer 716). For example, such a request may indicate that sensing resolution should be reduced, that sensing data should be captured at a faster rate, that sensing data should be captured using less resources, and that sensing data should be transmitted with a certain amount of delay.

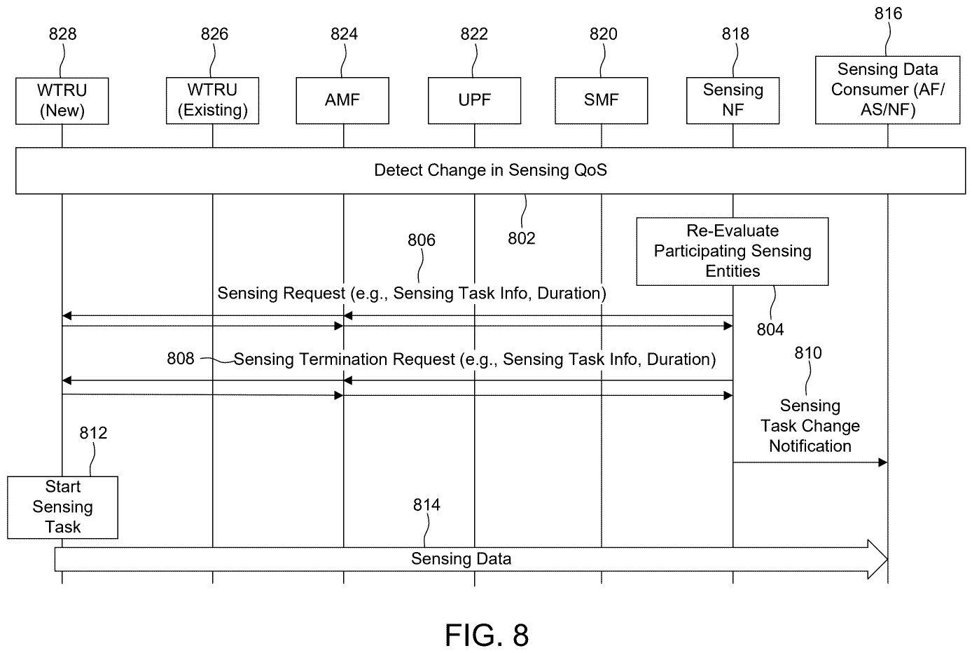

At 712, based on information received at 720, sensing network function 720 may select new sensing entities for the sensing task or may update configurations of sensing entities already participating in the sensing task (e.g., using procedures as described in connection with FIG. 8).

FIG. 8 is a sequence diagram of illustrative operations showing how sensing entities may be reselected for a sensing task once a change in the quality of service of a sensing task has been detected by a sensing entity, according to one or more embodiments of this disclosure.

At 802, sensing network function 818 (which may be the same as any of sensing network function 616 or 720) may determine that the QoS of a sensing task has been reduced (e.g., using the procedures as described in connection with FIGS. 6 or 7).

At 804, sensing network function 818 may determine that WTRU 826 (which may be the same as any of WTRUs 102a-102d, 340, 410, 508, 510, 556, 560, 624, or 728), or any sensing entity currently performing a sensing task, should be changed for another WTRU (or any suitable sensing entity) that is better suited to perform the sensing task.

Sensing network function 818, based on information about the sensing entities that is available to sensing network function 818, may reselect sensing entities that are better suited to perform the sensing task (e.g., WTRU 828). For example, sensing network function 818 may determine that one WTRU from a first and second WTRU are closer to a sensing target; sensing network function 818 may select the WTRU that is closer to the sensing target. Any one or more of the following parameters may be used to select new sensing entities: radio sensing characteristics; waveform; a time duration specifying how long transmitted data is valid for; a minimum delay that must be met when transmitting sensing data; proximity to a sensing target; a location of interest (e.g., a location of the target object); sensing data communication preferences that may be specified by a control plane or user plane (e.g., that specify how sensing data and control data should be transferred such as whether control data should be transferred over the control plane and whether sensing data should be sent over the user or data pane); a data reporting frequency; a sampling size of the data; a time frame at which the sensing task should be performed (e.g., which may be a combination of an exact time window such as 09:00-10:00 or a duration such as one hour); how fast a sensor needs to capture required information; a sensing mode (e.g., monostatic or bistatic sensing); supported sensing services 3GPP RAN sensing capabilities; non-3GPP sensing capabilities; sensor output types; types of available sensing data processing; data compression capabilities; protocol information for sensing data and control data (e.g., specifying UDP for sensing data and TCP for control data); network transmission information for sensing data and control data (e.g., using the 3GPP UE-WTRU interface (UU) for control data and the data plane for sensing data); data processing and analytics capabilities (e.g., object detection); sensing node roles (e.g., a data consumer role, a data provider role, a service provider role, or a service consumer role); authorization information (e.g., including information for different sensing roles as different sensing roles may need to be authorized separately); sensing entity availability or utilization (e.g., indicating how many other sensing tasks are currently being performed by a WTRU; how many new sensing tasks may be accepted by a RAN node; a priority level that the RAN node can assign to certain tasks); a sensing area that specifies the location and area covered by a WTRU; a frequency at which data can be reported; or a sampling size of the data.

In certain representative embodiments, at 804, a group of one or more alternate sensing entities applicable to certain tasks may be created. Such alternate sensing entities may be referenced in one of several ways such as by maintaining a list of candidate entities with an associated sensing task or by maintaining a list of candidate entities with associated sensing tasks. Such associated sensing tasks may be known as derived tasks.

At 806, sensing network function 818, AMF 824, or any suitable combination thereof, may send a request to perform a sensing task to WTRU 828 (which may be the same as any of WTRUs 102a-102d, 340, 410, 508, 510, 556, 560, 624, or 728) or any suitable new sensing entity. Such a request may include sensing task information and requirements of the sensing task (e.g., sensing frequency, waveform, or any parameter mentioned in regard to 804). Such a request may indicate when to initiate sensing (e.g., whether sensing should be started immediately or after some timer value). Such a request may indicate where WTRU 828 should send sensing data (e.g., information identifying sensing network function 818 or sensing data consumer 816) and what characteristics of sensing data should be sent (e.g., sampling information). At 806, WTRU 828 may send sensing data to any suitable entity (e.g., sensing network function 818, AMF 824, or sensing data consumer 816).

At 808, sensing network function 818 may send an instruction to terminate sensing to WTRU 826 (or any suitable sensing entity that no longer needs to perform a sensing task). Such an instruction may include information of the sensing task (e.g., a sensing task identifier). In certain representative embodiments, instructions for a derived task (e.g., as previously described above in connection with 804) or any suitable sensing task may be sent to WTRU 826. For example, new instructions may specify to maintain low quality information or to utilize metadata of other tasks.

At 810, sensing network function 818 may notify sensing data consumer 816 of any changes made to the sensing task (e.g., information related to what sensing entities have been added or prevented from further performing a sensing task).

At 812, WTRU 828 may initiate sensing based on received sensing task information and transmit sensing data to sensing data consumer 816.

FIG. 9 is a flowchart of illustrative steps for updating a sensing task based on quality of QoS, according to one or more embodiments of this disclosure.

Operations 902-914 may be performed by core network 924 (e.g., which may be the same as core networks 103, 115, or 190).

At 902, core network 924 may generate information for a sensing task indicating sensing task information and condition monitoring information indicating at least one condition to be monitored. In certain representative embodiments, core network 924 includes a sensing network function (e.g., sensing network function 616, 720, or 818). In certain representative embodiments, the at least one condition to be monitored may be any one or more of: a line of sight; a signal strength; a signal delay; a signal interference; an obstruction; a distance between the sensing entity and a sensing target; an available coverage area of the sensing entity; time of flight information; hardware malfunction information; a potential handover procedure; information related to mobility of the sensing entity; information related to mobility of the sensing target; a change in a battery level of the sensing entity; or information related to environmental changes. Determining that the QoS associated with the sensing task is insufficient includes one of: determining that the QoS associated with the sensing task is below a threshold or determining that one or more of the at least one condition has occurred

At 904, core network 924 may cause the generated information from 902 to be transmitted to a sensing entity (e.g., any one of WTRUs 102a-102d, 340, 410, 508, 510, 556, 560, 624, 728, 826, or 828). In certain representative embodiments, core network 924 transmits the generated information from 902 to be transmitted to an SMF, and the SMF transmits the sensing task information and the condition monitoring information to the sensing entity.

At 906, core network 924 may receive QoS change information indicating a change in at least condition from 902. In certain representative embodiments, receiving the QoS change information includes receiving the QoS information from any one of a sensing entity or a network function of a core network (e.g., an AMF, SMF, UPF).

At 908, core network 924 may determine that a QoS associated with the sensing task is insufficient based on the QoS change information. In certain representative embodiments, core network 924 determining that the QoS associated with the sensing task is insufficient also includes determining that the QoS associated with the sensing task is insufficient for a period of time.

At 910, core network 924 may determine at least one modification to the sensing task based on the QoS change information and based on determining that the QoS associated with the sensing task is insufficient. In certain representative embodiments, core network 924 further determines which condition was changed and determines that the QoS associated with the sensing task is insufficient temporarily based on that the condition was changed.

At 912, core network 924 may generate updated sensing task information based on at least on modification determined from 910.

At 914, core network 924 may cause the updated sensing task information to be transmitted to at least one sensing entity such that the at least one sensing entity is configured based on the updated sensing task information. In certain representative embodiments, the updated sensing task information includes an instruction causing at least one sensing entity to terminate a respective sensing task. In certain representative embodiments, the updated sensing task information includes an instruction to initiate a respective task using the at least one sensing entity. In such embodiments, initiating a respective sensing task using at least one sensing entity is based on information associated with the at least one sensing entity. The information associated with the at least one sensing entity may include any one or more of the following: radio sensing characteristics; waveform; an availability time frame; a delay setting; information related to proximity to a sensing target; a location of interest; sensing data communication preferences; a frequency at which data is reported; a sampling size of data reported; a sensing speed; a sensing mode; sensing capability information; a sensing data output type; data compression ability information; previously performed task information; bandwidth information; or authorization information.

Operations 916-922 may be performed by WTRU 926 (which may be the same as any of WTRUs 102a-102d, 340, 410, 508, 510, 556, 560, 624, 728, or, 826). WTRU 926 may be in communication with a wireless network that may include at least one entity of core network 924.

At 916, WTRU 926 receives, from a wireless network, information for a sensing task. The information for the sensing task indicates sensing task information and condition monitoring information indicating at least one condition to be monitored. When core network 924 causes sensing task information to be transmitted to a sensing entity, the sensing entity may be WTRU 926. In other words, core network 924 may cause the information for the sensing task to be transmitted to WTRU 926 at 904, and WTRU 926 receives the information for the sensing task at 916.

At 918, WTRU 926 transmits, to the wireless network, QoS change information indicating a change in the at least one condition. When core network 924 receives QoS change information at 906, QoS change information may be received from WTRU 926 at 918.

At 920, WTRU 926 receives, from the wireless network updated sensing task information, such that a core network (e.g., core network 924) determines that a QoS associated with the sensing task is insufficient based on the QoS change information. Such a core network also determines at least one modification to the sensing task based on the QoS change information and determines that the QoS associated with the sensing task is insufficient. When core network 924, at 914, causes the updated sensing task information to be transmitted to at least one sensing entity, the at least one sensing entity may be WTRU 926. In other words, WTRU 926 may receive updated sensing task information from core network 924 at 920.

At 922, WTRU 926 is configured based on the updated sensing task configuration.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a core network, the method comprising:
generating information for a sensing task, wherein the information for the sensing task indicates:
(a)sensing task information, and
(b)condition monitoring information indicating at least one condition to be monitored;
causing the information for the sensing task to be transmitted to a sensing entity;
receiving quality of service (QoS) change information indicating a change in the at least one condition;
determining that a QoS associated with the sensing task is insufficient based on the QoS change information;
determining at least one modification to the sensing task based on:
(a)the QoS change information, and
(b) determining that the QoS associated with the sensing task is insufficient;
generating updated sensing task information based on the at least one modification; and
causing the updated sensing task information to be transmitted to at least one sensing entity, wherein the at least one sensing entity is configured based on the updated sensing task information.

2. The method of claim 1, wherein receiving the QoS change information comprises receiving the QoS change information from any one of a sensing entity or a network function of the core network.

3. The method of claim 1, further comprising determining which condition of the at least one condition was changed, wherein determining that the QoS associated with the sensing task is insufficient comprises determining that the QoS associated with the sensing task is insufficient temporarily based on the condition that was changed.

4. The method of claim 1, wherein the updated sensing task information comprises an instruction causing the at least one sensing entity to terminate a respective sensing task.

5. The method of claim 1, wherein the at least one condition to be monitored comprises any one or more of:
a line of sight;
a signal strength;
a signal delay;
a signal interference;
an obstruction;
a distance between the sensing entity and a sensing target;
an available coverage area of the sensing entity;
time of flight information;
hardware malfunction information;
a potential handover procedure;
information related to mobility of the sensing entity;
information related to mobility of the sensing target;
a change in a battery level of the sensing entity; or
information related to environmental changes; and
wherein determining that the QoS associated with the sensing task is insufficient comprises one of: determining that the QoS associated with the sensing task is below a threshold or determining that one or more of the at least one condition has occurred.

6. The method of claim 1, wherein the updated sensing task information comprises an instruction to initiate a respective sensing task using the at least one sensing entity.

7. The method of claim 6, wherein initiating a respective sensing task using the at least one sensing entity is based on information associated with the at least one sensing entity, wherein the information associated with the at least one sensing entity comprises any one or more of:
radio sensing characteristics;
waveform;
an availability time frame;
a delay setting;
information related to proximity to a sensing target;
a location of interest;
sensing data communication preferences;
a frequency at which data is reported;
a sampling size of data reported;
a sensing speed;
a sensing mode;
sensing capability information;
a sensing data output type;
data compression ability information;
previously performed task information;
bandwidth information; or
authorization information.

8. The method of claim 1, wherein determining that the QoS associated with the sensing task is insufficient comprises determining that the QoS associated with the sensing task is insufficient for a period of time.

9. The method of claim 1, wherein the core network comprises a sensing network function.

10. The method of claim 1, wherein causing the information for the sensing task to be transmitted to the sensing entity comprises transmitting the information for the sensing task to a session management function (SMF) of the core network, wherein the SMF transmits (a) the sensing task information, and (b) the condition monitoring information to the sensing entity.

11. A wireless transmit/receive unit (WTRU), comprising:
a processor; and
a transceiver, wherein the WTRU is configured to:
receive, from a wireless network, information for a sensing task, wherein the information for the sensing task indicates:
(a) sensing task information, and
(b) condition monitoring information indicating at least one condition to be monitored;
transmit, to the wireless network, quality of service (QoS) change information indicating a change in the at least one condition; and
receive, from the wireless network, updated sensing task information, wherein:
a core network determines that a QoS associated with the sensing task is insufficient based on the QoS change information and at least one modification to the sensing task based on:
(a) the QoS change information, and
(b) determining that the QoS associated with the sensing task is insufficient; and
configure the WTRU based on the updated sensing task information.

12. A system of one or more entities of a core network, the system comprising at least one processor configured to:
generate information for a sensing task, wherein the information for the sensing task indicates:
(a)sensing task information, and
(b)condition monitoring information indicating at least one condition to be monitored;
cause the information for the sensing task to be transmitted to a sensing entity;
receive quality of service (QoS) change information indicating a change in the at least one condition;
determine that a QoS associated with the sensing task is insufficient based on the QoS change information;
determine at least one modification to the sensing task based on:
(a)the QoS change information, and
(b) determining that the QoS associated with the sensing task is insufficient;
generate updated sensing task information based on the at least one modification; and
cause the updated sensing task information to be transmitted to at least one sensing entity, wherein the at least one sensing entity is configured based on the updated sensing task information.

13. The system of claim 12, wherein, when receiving the QoS change information, the at least one processor is further configured to receive the QoS change information from any one of a sensing entity or a network function of the core network.

14. The system of claim 12, wherein the at least one processor is further configured to determine which condition of the at least one condition was changed, wherein, when determining that the QoS associated with the sensing task is insufficient, the at least one processor is further configured to determine that the QoS associated with the sensing task is insufficient temporarily based on the condition that was changed.

15. The system of claim 12, wherein the updated sensing task information comprises an instruction causing the at least one sensing entity to terminate a respective sensing task.

16. The system of claim 12, wherein the at least one condition to be monitored comprises any one or more of:
a line of sight;
a signal strength;
a signal delay;
a signal interference;
an obstruction;
a distance between the sensing entity and a sensing target;
an available coverage area of the sensing entity;
time of flight information;
hardware malfunction information;
a potential handover procedure;
information related to mobility of the sensing entity;
information related to mobility of the sensing target;
a change in a battery level of the sensing entity; or
information related to environmental changes; and
wherein determining that the QoS associated with the sensing task is insufficient comprises one of: determining that the QoS associated with the sensing task is below a threshold or determining that one or more of the at least one condition has occurred.

17. The system of claim 12, wherein the updated sensing task information comprises an instruction to initiate a respective sensing task using the at least one sensing entity.

18. The system of claim 17, wherein initiating a respective sensing task using the at least one sensing entity is based on information associated with the at least one sensing entity, wherein the information associated with the at least one sensing entity comprises any one or more of:
radio sensing characteristics;
waveform;
an availability time frame;
a delay setting;
information related to proximity to a sensing target;
a location of interest;
sensing data communication preferences;
a frequency at which data is reported;
a sampling size of data reported;
a sensing speed;
a sensing mode;
sensing capability information;
a sensing data output type;
data compression ability information;
previously performed task information;
bandwidth information; or
authorization information.

19. The system of claim 12, wherein, when determining that the QoS associated with the sensing task is insufficient, the at least one processor is further configured to determine that the QoS associated with the sensing task is insufficient for a period of time.

20. The system of claim 12, wherein the core network comprises a sensing network function.
